(19) United States
(12) Patent Application Publication
(10) Pub. No.: US 2021/0147303 A1
(43) Pub. Date: May 20, 2021

(54) METHOD TO REPAIR CMC COMPONENTS

(71) Applicant: Rolls-Royce High Temperature Composites Inc., Cypress, CA (US)

(72) Inventors: Camila S. Bortoluzzi, Huntington Beach, CA (US); Sungbo Shim, Irvine, CA (US); Pathikumar Sellappan, Seal Beach, CA (US)

(21) Appl. No.: 17/088,897

(22) Filed: Nov. 4, 2020

Related U.S. Application Data
(60) Provisional application No. 62/935,730, filed on Nov. 15, 2019.

(51) Int. Cl. C04B 35/80; C04B 35/628; C04B 35/657

(52) U.S. Cl. CPC C04B 35/80; C04B 2235/616; C04B 35/62886; C04B 35/62884; C04B 35/62863; C04B 35/62871; C04B 35/657; C04B 2235/3826; C04B 2235/3873; C04B 2235/3839; C04B 2235/3847; C04B 2235/425; C04B 2235/427; C04B 2235/424; C04B 2235/5244; C04B 2235/524; C04B 2235/5252; C04B 2235/614; C04B 35/62894

(57) ABSTRACT

A method of producing a CMC component that includes forming a preform having a plurality of ceramic fiber plies with each ply occupying a predetermined position; rigidizing the preform with a fiber interphase coating; inspecting the preform to determine which of the plies has partially or fully delaminated; reworking the delaminated plies in the preform; infiltrating a ceramic slurry into the preform to form a green body; optionally, conducting a secondary operation on the green body; and infiltrating the green body with a molten silicon or silicon alloy to form the CMC component. The step of reworking delaminated plies may also be applied to a green body formed after ceramic slurry infiltration into a rigidized fiber preform.

### RELATED APPLICATION

This present patent document claims the benefit of priority under 35 U.S.C. § 119(e) to U.S. Provisional Patent Application No. 62/935,730, which was filed on Nov. 15, 2019, and is hereby incorporated by reference in its entirety.

### TECHNICAL FIELD

This disclosure relates generally to a method of repairing a ceramic matrix composite (CMC) component during the manufacturing thereof. More specifically, this disclosure relates to repairing a CMC component in which one or more plies has become partially or fully delaminated during the manufacturing process.

### BACKGROUND

The statements in this section merely provide background information related to the present disclosure and may not constitute prior art.

A ceramic matrix composite (CMC), which includes ceramic fibers in the shape of a fiber preform embedded in a ceramic matrix, exhibits a combination of properties that makes the ceramic matrix composite a promising candidate for use in components that are utilized in a variety of industrial applications that require excellent thermal and mechanical properties along with low weight. However, the high manufacturing costs associated with forming these CMC components represent a key barrier to the overall acceptance and commercialization of such components in many of these industrial applications.

During the manufacturing of a component, a ceramic matrix composite (CMC) may develop flaws or defects of various sizes and shapes due to the complex microstructures that are formed and the multiple processing or manufacturing steps that are necessary. These flaws and defects may comprise relatively large, discrete defects, such as the partial or full delamination of one or more or more fiber plies used to form the fiber preform, or microscopic flaws, such as excessive porosity and small cracks. The occurrence of these flaws and defects give rise to increased manufacturing costs through the creation of a large amount of scrapped CMC components.

### DRAWINGS

In order that the disclosure may be well understood, there will now be described various forms thereof, given by way of example, reference being made to the accompanying drawings, in which:

FIG. 1 is a flowchart of a method for forming a ceramic matrix composite (CMC) component according to the teachings of the present disclosure that includes process steps for reworking any partially or fully delaminated plies encountered during the manufacturing process;

FIG. 2A illustrates the partial delamination of the top ply in a fiber preform comprising a composite laminate of multiple plies;

FIG. 2B is another illustration of the partial delamination of a ply in a fiber preform;

FIG. 3 demonstrates the application of a rework slurry between the partially delaminated ply of FIGS. 2A and 2B and the ply that is still part of the fiber preform to which the delaminated ply should be bonded;

FIG. 4 is a top-down view of the reworked delaminated ply of FIGS. 2A and 2B rebonded in the predetermined position with the other plies in the fiber preform and manually held in place;

FIG. 5 is a side view of the fiber preform showing slurry touch-up performed on the delaminated ply of FIGS. 2A and 2B;

FIG. 6 is a side view of a reworked fiber preform with the delaminated ply of FIGS. 2A and 2B rebonded in the predetermined position and held in place with mechanical fasteners;

FIG. 7 is a top-down view of a reworked fiber preform with the delaminated ply of FIGS. 2A and 2B rebonded in the predetermined position and held in place with mechanical fasteners;

FIG. 8 illustrates the complete or full delamination of the top ply in a fiber preform comprising a composite laminate of multiple plies and the application of a wetting agent solution to the predetermined position on the plies in the fiber preform to which the delaminated ply should be attached;

FIG. 9 provides additional illustration of complete or full delamination of the top ply in the fiber preform of FIG. 8 and the application of a rework slurry to the predetermined position on the plies in the fiber preform to which the delaminated ply should be attached;

FIG. 10 demonstrates the application of the rework slurry to the surface of the delaminated ply of FIGS. 8 and 9;

FIG. 11 is a side view of the reworked delaminated ply of FIGS. 8 and 9 rebonded in the predetermined position with the other plies in the fiber preform and manually held in place;

FIG. 12 is a side view of the fiber preform showing slurry touch-up performed on the delaminated ply of FIGS. 8 and 9;

FIG. 13 is a top-down view of a reworked fiber preform with the delaminated ply of FIGS. 8 and 9 rebonded in the predetermined position and held in place with mechanical fasteners;

FIG. 14 is a flowchart of another method for forming a ceramic matrix composite (CMC) component according to another aspect of the present disclosure that includes process steps for reworking any partially or fully delaminated plies encountered during the manufacturing process; and

FIG. 15 is a flowchart of another method of producing a ceramic matrix composite (CMC) component according to another aspect of the present disclosure.

The drawings described herein are for illustration purposes only and are not intended to limit the scope of the present disclosure in any way.

### DETAILED DESCRIPTION

The present disclosure generally provides a method of repairing a ceramic matrix composite (CMC) component during the manufacturing thereof, wherein one or more fiber plies has become partially or fully delaminated from the fiber preform during the manufacturing process. More specifically, a rework slurry is utilized to bond or rebond the delaminated plies to the fiber preform in a predetermined position. Once the rework slurry is applied, the reworked ply is held in the predetermined position of the fiber preform until dry in order to ensure that the plies have been rejoined properly. The benefits associated with implementation of the teachings of the present disclosure include, without limitation, reducing the manufacturing cost associated with the CMC components due to a reduced or lower scrap rate and providing a means to repair delaminated components during processing, thereby, reducing the amount of time, effort, and cost associated with having to repair or fix the components prior to use in a desired application.

A ceramic matrix composite (CMC) component or article is generally made from a lay-up of a plurality of continuous ceramic fibers, formed to a desired shape. At this stage in the production of a CMC article or component, the lay-up is generally known as a ceramic fiber preform, fiber preform, or preform. The fiber preform, which may be partially rigid or non-rigid, may be constructed in any number of different configurations. For example, the preform may be made of filament windings, braiding, and/or knotting of fibers, and may include two-dimensional and three-dimensional fabrics, unidirectional fabrics, and/or nonwoven textiles. Layers of the fibers, fabrics, and textiles may create a composite laminate structure in which each layer represents a ply. Thus, the fiber preform many comprise, consist essentially of, or consist of a plurality of such shaped fiber plies. These fiber plies may be generally linear or flat, include some degree of curvature, or be formed into a more complex shape.

Delamination may be defined as the separation of a single ply or multiple plies from the other fiber plies or layers that make up the fiber preform. This delamination generally occurs along the plane that exists between the various layers or plies. The occurrence of this delamination may be only partial, such that at least a portion of the ply is still attached to the fiber preform in one or more locations. The occurrence of this delamination may also be full or complete, such that the entire ply is separated from the fiber preform.

The following description is merely exemplary in nature and is in no way intended to limit the present disclosure or its application or uses. For example, the rework or repair method according to the teachings contained herein is described throughout the present disclosure in conjunction with a manual operation in order to more fully illustrate the functionality of the system and the use thereof. The automation of such a rework or repair method or the automation of one or more parts of such method in the manufacturing process of a CMC component is contemplated to be within the scope of the present disclosure.

For the purpose of this disclosure the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)”at the end of the element. For example, “at least one source”, “one or more sources”, and “source(s)” may be used interchangeably and are intended to have the same meaning.

For purposes of promoting an understanding of the principles of the present disclosure, reference will now be made to the embodiments illustrated in the drawings, and specific language will be used to describe the same. It should be understood that throughout the description, corresponding reference numerals indicate like or corresponding parts and features. One skilled in the art will further understand that any properties reported herein represent properties that are routinely measured and may be obtained by multiple different methods. The methods described herein represent one such method and other methods may be utilized without exceeding the scope of the present disclosure.

No limitation of the scope of the present disclosure is intended by the illustration and description of certain embodiments herein. In addition, any alterations and/or modifications of the illustrated and/or described embodiment(s) are contemplated as being within the scope of the present disclosure. Further, any other applications of the principles of the present disclosure, as illustrated and/or described herein, as would normally occur to one skilled in the art to which the disclosure pertains, are contemplated as being within the scope thereof.

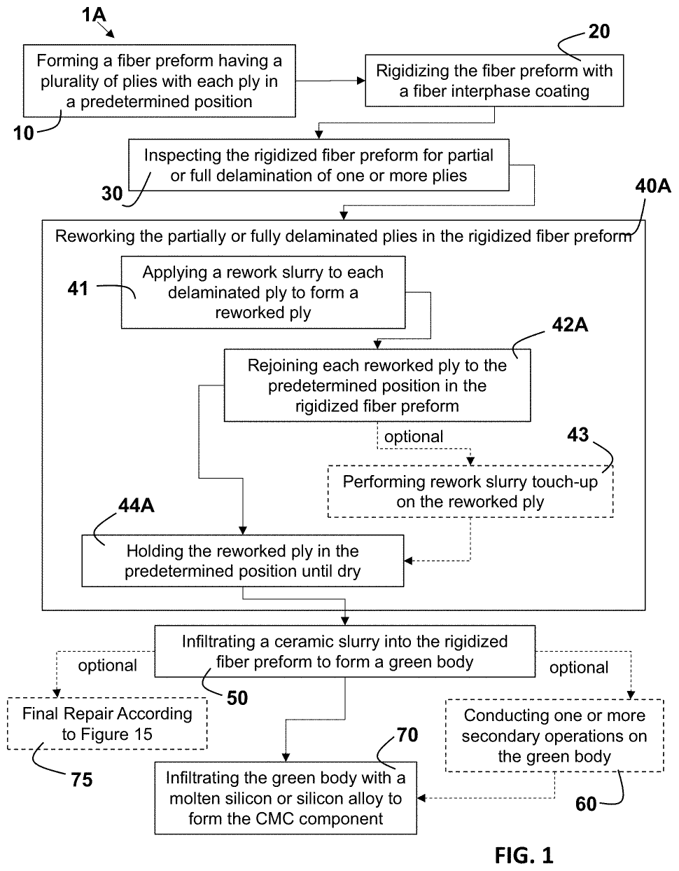

Referring to FIG. 1, a method 1A of producing a ceramic matrix composite (CMC) component is provided. This method 1A comprises the steps of: forming 10 a fiber preform that comprises a plurality of ceramic fiber plies with each ceramic fiber ply occupying a predetermined position in the fiber preform; rigidizing 20 the fiber preform with a fiber interphase coating; inspecting 30 the rigidized fiber preform to determine which of the plurality of plies has partially or fully delaminated; reworking 40A the partially or fully delaminated plies in the rigidized fiber preform; infiltrating 50 a ceramic slurry into the rigidized fiber preform to form a green body; optionally, conducting 60 one or more secondary operations on the green body; and infiltrating 70 the green body with a molten silicon or silicon alloy to form the CMC component.

The step of reworking 40A the partially or fully delaminated plies in the rigidized fiber preform is further subdivided into multiple steps 41-44A that are involved in such a repair process. This repair process or steps involved in reworking 40A the partially or fully delaminated plies in the rigidized fiber preform comprises applying 41 a rework slurry to each delaminated ply to form a reworked ply; rejoining 42A each reworked ply to the predetermined position in the fiber preform; optionally, performing 43 rework slurry touch-up on the reworked ply; and holding 44A the reworked ply in the predetermined position until dry.

Still referring to FIG. 1, the fiber preform is formed by layering a plurality of plies together, with each ply having a predetermined position in the fiber preform. The fibers used in the preform, furthermore, may comprise any number of different materials capable of withstanding the high processing temperatures used in preparing and operating CMC components, such as, but not limited to, carbon fibers, ceramic fibers (e.g., silicon carbide, alumina, mullite, zirconia, or silicon nitride), which can be crystalline or amorphous. The ceramic fibers may be suitably coated by various methods. Alternatively, the fiber preform comprises fibers that include one or more of silicon carbide (SiC), silicon nitride (Si₃N₄), or a mixture or combination thereof. Each of the fibers is individually selected and may be of the same or different composition and/or diameter. Alternatively, the fibers are the same in at least one of said composition and/or diameter. The ceramic fiber filaments may have a diameter that is between about 1 micrometer (μm) to about 50 μm; alternatively, about 5 μm to about 30 μm; alternatively, about 10 μm to about 20 μm.

The ceramic fibers in the preform may be treated or rigidized 20 by applying a single fiber interphase coating or a plurality of such coatings thereto. The general purpose of the interphase coating(s) is to facilitate and/or enhance compatibility between the ceramic fibers and the ceramic slurry and/or the molten silicon or silicon alloy that is subsequently added in order to densify the preform and form the ceramic matrix composite (CMC). The rigidizing of the fiber preform may also enhance the toughness (e.g., crack reduction) exhibited by the final CMC component, as well as reduce or prevent reaction between the ceramic fibers and the molten metal or metal alloy.

The interphase coating(s) may be applied to the fiber preform using any method known to one skilled in the art, including but not limited to Chemical Vapor Infiltration (CVI) or Chemical Vapor Deposition (CVD) processes; alternatively, by a CVI process. Several examples of such interphase coatings include, without limitation, carbon, aluminum nitride, boron nitride, silicon nitride, silicon carbide, boron carbide, metal borides, transition metal silicides, transition metal oxides, transition metal silicates, rare earth metal silicates, and mixtures or combinations thereof. Alternatively, the fiber interphase coating comprises silicon carbide (SiC), silicon nitride (Si₃N₄), or a mixture or combination thereof. When used, the fiber interphase coating(s) may have a thickness that is in the range of about 0.01 micrometers (μm) to about 20 micrometers (μm); alternatively between about 0.05 μm to 15 μm; alternatively from about 0.1 μm to about 10 μm; alternatively, from about 0.5 μm to about 5 μm.

Inspecting the rigidized fiber preform for partial or full delamination of one or more plies may include any nondestructive testing methods known in the art, including, but not limited to, visual inspection, tap testing (i.e. identification of sound differences), ultrasound, radiography, and infrared imaging. Alternatively, the inspection is by observation or visual inspection. This visual inspection may be performed by an operator or performed using automated optical or visual imaging equipment or an automated system that incorporates such optical or visual imaging equipment.

Reworking 40A the partially or fully delaminated plies in the rigidized fiber preform includes applying a rework slurry to each delaminated ply to form a reworked ply. The application of a rework slurry to each delaminated ply in order to form a reworked ply generally comprises one or more of applying the rework slurry directly to the delaminated ply; applying the rework slurry directly to the ply in the fiber preform to which the delaminated ply should be attached; or applying the rework slurry between the delaminated ply and the ply in the fiber preform to which the delaminated ply should be attached. The rework slurry may be applied by a variety of different techniques, such as, without limitation, spraying, dipping, pouring, flowing, brushing, or the like.

The rework slurry may comprise, consist essentially of, or consist of a plurality of solid particulate fillers, one or more reactive additives, a solvent, and optionally, one or more dispersants, binders, and/or gelation polymers. The rework slurry may comprise a solid loading in the range of about 5 vol. % to about 80 vol. %; alternatively in the range of about 10 vol. % to about 70 vol. %; alternatively, in the range of about 15 vol. % to about 65 vol. %; alternatively, in the range of about 20 vol. % to about 60 vol. %, relative to the overall volume of the ceramic slurry.

The solid particulate fillers in the rework slurry may comprise, without limitation aluminum nitride, aluminum diboride, boron carbide, alumina, mullite, zirconia, carbon, silicon carbide, silicon nitride, transition metal nitrides, transition metal borides, rare earth oxides, and mixtures and combinations thereof. Alternatively, the solid particulate fillers comprise silicon carbide (SiC), silicon nitride (Si₃N₄), or a mixture or combination thereof. The solid particulate fillers may comprise one or more regular or irregular shapes including, without limitation, spheres and rods. The size of the solid particulate fillers may vary, but generally, exhibit a diameter, i.e., the length of major dimension, that is less than about 50 micrometers; alternatively in the range of about 100 nanometers (nm) up to about 50 micrometers (μm); alternatively, greater than 200 nm; alternatively, between about 300 nm and about 25 μm.

The solid particulate fillers are typically present in various sizes and give rise to a particle size distribution that can be characterized by a mean average particle size or diameter. These solid particulate fillers may result in a mono-, bi-, or multi-modal distribution being observed upon the measurement of a particle size distribution for the rework slurry using any conventional technique, such as sieving, microscopy, Coulter counting, dynamic light scattering, or particle imaging analysis, to name a few.

The one or more reactive additives included in the composition of the rework slurry may comprise, without limitation, at least one of graphite, diamond, carbon black, molybdenum (Mo), and tungsten (W).

The solvent present in the rework slurry may be any solvent that is known to be used for the manufacturing of a ceramic matrix composite (CMC) component. Several examples, of such solvents include, but are not limited to, polyvinylpyrrolidone, water, and alcohols, such as isopropanol or polyvinyl alcohol, to name a few, as well as mixtures or combinations thereof. The solvent may also comprise a carbonaceous resin, including but not limited to a phenolic resin in combination with furfuryl alcohol.

The one or more dispersants, optionally included in the composition of the rework slurry may comprise, but not be limited to, an anionic, cationic, or nonionic surfactant, including for example, polyethylene glycol (PEG). The optional binders and/or gelation polymers, included in the composition of the rework slurry may comprise, without limitation, an acrylic emulsion polymeric binder, polyethyleneimine, and carboxymethyl cellulose.

Still referring to FIG. 1, after the reworked ply is held in place until dry 44A (i.e., re-bonded in the predetermined position of the fiber preform), a ceramic slurry is infiltrated 50 into the rigidized fiber preform to form a green body. The composition of the ceramic slurry used to infiltrate 50 the fiber preform may be the same composition or a different composition than that used for the rework slurry. Alternatively, the composition of the ceramic slurry used to infiltrate 50 the fiber preform is the same composition as that used for the rework slurry. As the ceramic slurry infiltrates 50 the fiber preform, the solid particulate fillers flow into the pores and interstices that exist between the ceramic fibers. The infiltration 50 of the ceramic slurry may be accomplished in a single step or may comprise multiple infiltration steps in order to ensure that the fiber preform is fully impregnated with the solid particulate fillers. Each additional infiltration step may be performed using a ceramic slurry composition that is either the same as or different form the composition used in the first infiltration or impregnation step.

Still referring to FIG. 1, following slurry infiltration 50, the resulting green body may be subjected to 60 one or more secondary operations when necessary or desirable. Several examples of these secondary operations include, without limitation, the removal of excess ceramic slurry, defects, or other surface imperfections from the green body, as well as drying the green body in order to remove water or other residual solvents that may remain within the green body. The removal of the imperfections or defects may be accomplished by any means known to one skilled in the art, including but not limited to grinding, sanding, brushing, or polishing with or without the an abrasive medium. The drying of the green body may be accomplished by any suitable manner, including without limitation, drying at ambient temperature under vacuum at about 1 Torr or at ambient pressure along with exposure to a temperature that ranges from ambient, room temperature up to 400° C.; alternatively, the temperature is greater than 100° C.; alternatively, up to about 150° C. A ramp rate for raising the temperature from ambient temperature to a predetermined value may be 2° C. per minute; alternatively, less than 2° C. per minute; alternatively, from about 1° C. per minute to about 3° C. per minute. When the solvent in the rework slurry comprises a carbonaceous resin, the green body (including the rework slurry) is thermally dried or cured in a temperature range of about 100° C. to about 200° C. in order to provide bonding strength prior to melt infiltration of the silicon or silicon alloy. After slurry infiltration 50, if a defect, such as partial or full delamination of a ply, is present in the green body, the green body may be subjected to a final repair process 75.

One of the final steps in the fabrication of a ceramic matrix composite (CMC) is melt infiltration, in which a molten metal or metal alloy is infiltrated 70 into any porosity that remains or is still present in the fiber preform. After completion of any optional secondary processing operations 60, a molten metal or metal alloy is infiltrated 70 into the green body. This molten metal or metal alloy occupies any remaining interstices that may be present between the solid particulate fillers and ceramic fibers until the green body is fully densified to less than about 7% porosity; alternatively, 5% porosity; alternatively, less than about 3% porosity; alternatively, between 0% and about 1% porosity in the finished CMC component.

As used herein the term “metal or alloy” is intended to refer to a matrix infiltrant, which may comprise any number of materials such as, but not limited to, polymers, metals, and ceramics. Several specific examples of metals that may be used to infiltrate the fiber preform may comprise, without limitation, aluminum, silicon, nickel, titanium, or mixtures and alloys thereof. Several specific examples of ceramics that may be used to infiltrate the fiber preform may include, without limitation, silicon carbide, silicon nitride, alumina, mullite, zirconia, and combinations thereof. Alternatively, the metal or metal alloy infiltrant is silicon, silicon carbide, silicon nitride, or a combination thereof (e.g., silicon/silicon carbide, etc.). When desirable, the metal or metal alloy particles may be combined with other additives or process aids.

The infiltration of the metal or metal alloy may be accomplished at a temperature of at least 1,000° C.; alternatively, about 1,200° C. to about 1,700° C.; alternatively, between about 1,350° C. and about 1,550° C. The duration of the infiltration may range between about 5 minutes to 5 hours; alternatively, from 15 minutes to 4 hours; alternatively, from about 20 minutes to about 2 hours. The infiltration of the molten silicon or silicon alloy may optionally be carried out under vacuum or in an inert environment under atmospheric pressure in order to minimize evaporative losses. Following the infiltration of the metal or metal alloy, the ceramic matrix composite may optionally be machined to form a suitable finished component or article.

According to another aspect of the present disclosure, a method of reworking or repairing one or more partially or fully delaminated plies in a predetermined position of a rigidized fiber preform during the manufacturing of a CMC component is provided. Referring once again to FIG. 1, this method is similar to or substantially the same as the method 40A or process described above with respect to steps 41-44A.

### EXAMPLE 1

### Repair of Partial Delamination

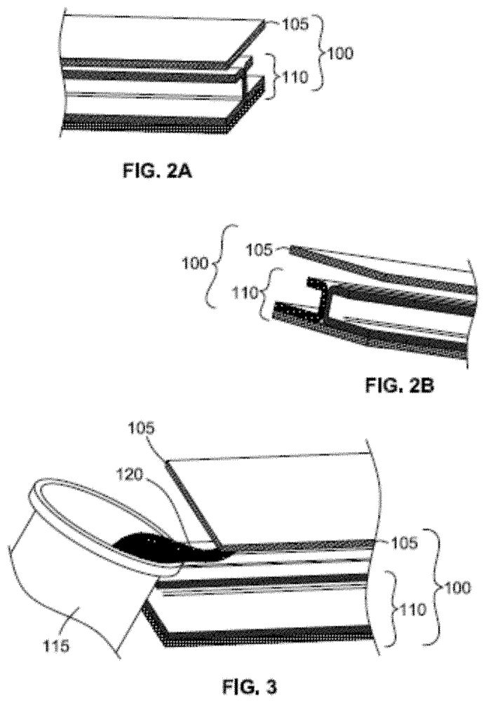

Referring now to FIGS. 2A and 2B, partial delamination of a ply in a fiber preform 100 is demonstrated in which at least one of the plies or sub-laminates 105 is separated from the remaining plies 110 in the fiber preform 100, but is still attached thereto. The fiber preform 100 as shown in this Example is relatively flat with only a small amount of curvature. However, the fiber preform 100 does not necessarily need to be flat, but rather can be formed or shaped into a more complex structure.

A rework slurry 115 with a 50 vol. % solid loading and consisting of 2.5 pm nominal size silicon carbide (SiC) powder, an acrylic emulsion polymeric binder (Duramax™, Rohm and Haas Co., Philadelphia, Pa.), and water is prepared by ball milling for 4 hours and then placed into a container. Referring now to FIG. 3, this rework slurry 115 is applied between the delaminated ply 105 and the ply that remains in the fiber preform 110 to which the delaminated ply 105 should be bonded. When desirable, a wetting agent solution containing an ethoxylated acetylenic diol (0.1% Dynol solution, Evonik Industries, Allentown, Pa.) may be applied onto the surface of the plies prior to the application of the rework slurry 115.

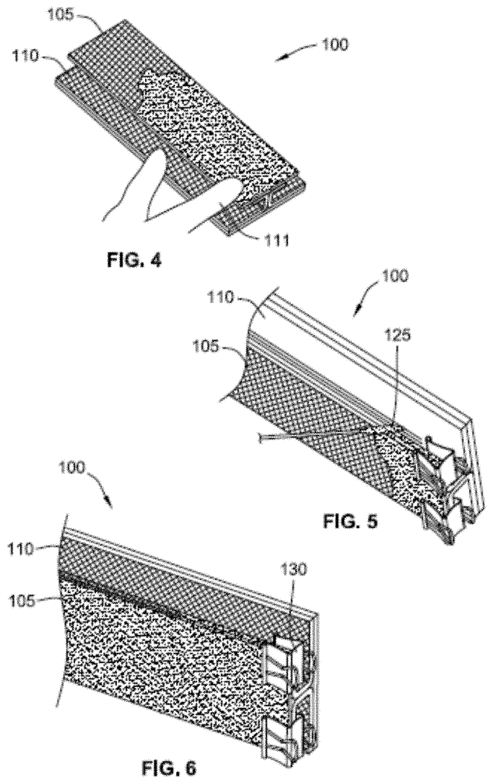

Referring now to FIG. 4, the delaminated ply 105 is glued or reattached back together with the plies 110 that remain as part of the fiber preform 100 in the predetermined position and is manually held 111 in place to assist in bonding between the delaminated ply 105 and the plies 110 remaining in the fiber preform 100. When desirable or necessary, rework slurry touch-up 125 may be performed on the reworked ply 105 as shown in FIG. 5. Clips, fasteners, or the like 130 may be added as shown in FIGS. 6 and 7 to hold plies 105, 110 together during final slurry touch up 125 and/or to ensure that the plies 105, 110 are joined properly and will not separate during drying. This drying is generally performed until the rework slurry is substantially or completely dried. This drying may be accomplished at an ambient temperature (about 20° C. to about 25° C.) for a predetermined amount of time, such as, for example, 8 hours, 12 hours, 16 hours, or the like, followed by exposure to an elevated temperature for at least one hour; alternatively, for two hours or more. This elevated temperature may represent a single temperature or multiple temperatures, such as, for example, about 1 hour at 75° C. and 1 hour at 150° C. After the rework slurry is dried, the part is infiltrated 50 with a ceramic slurry to form a green body. This green body is then infiltrated 70 with a silicon alloy melt for final densification of the CMC component.

### EXAMPLE 2

### Repair of Full Delamination

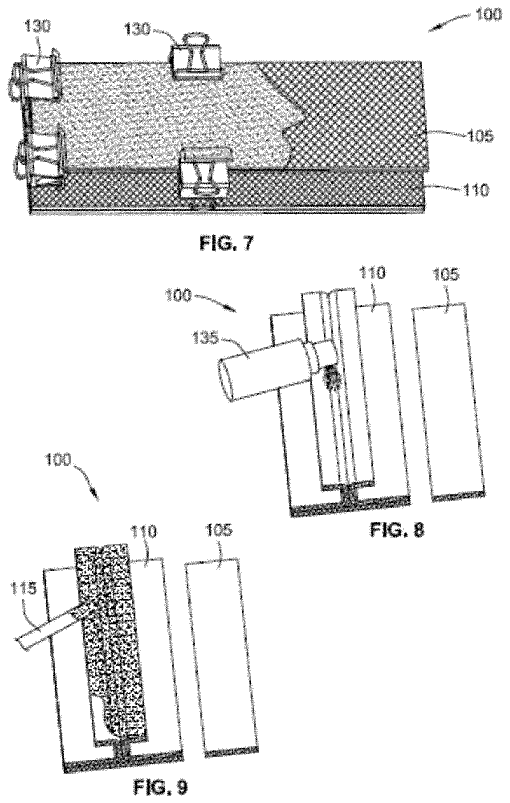

Referring now to FIGS. 8 and 9, full delamination of a ply in a fiber preform 100 is demonstrated in which at least one of the plies or sub-laminates 105 is completely separated from the remaining plies 110 in the fiber preform 100, such that the ply 105 is no longer attached thereto. The fiber preform 100 as shown in this Example is relatively flat with only a small amount of curvature. However, the fiber preform does not necessarily need to be flat, but rather can be formed or shaped into a more complex structure.

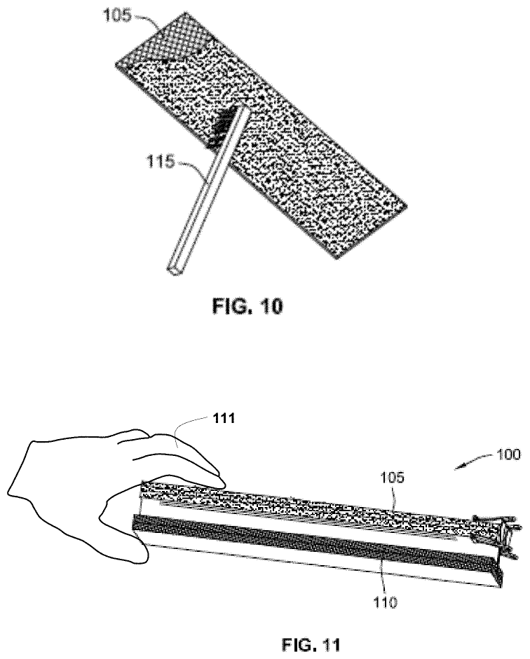

A rework slurry 115 with a 50 vol. % solid loading and consisting of 2.5 μm nominal size silicon carbide (SiC) powder, an acrylic emulsion polymeric binder (Duramax™, Rohm and Haas Co., Philadelphia, Pa.), and water is prepared by ball milling for 4 hours and then placed into a container. Referring now to only FIG. 8, a wetting agent solution containing an ethoxylated acetylenic diol (0.1% Dynol solution, Evonik Industries, Allentown, Pa.) is applied 135 onto the surface of the plies 105, 110 prior to the application of the rework slurry. Referring now to FIGS. 9 and 10, the rework slurry 115 is applied directly to the delaminated ply 105 (see FIG. 10) and the ply 110 that remains in the fiber preform 100 to which the delaminated ply 105 should be bonded (see FIG. 9).

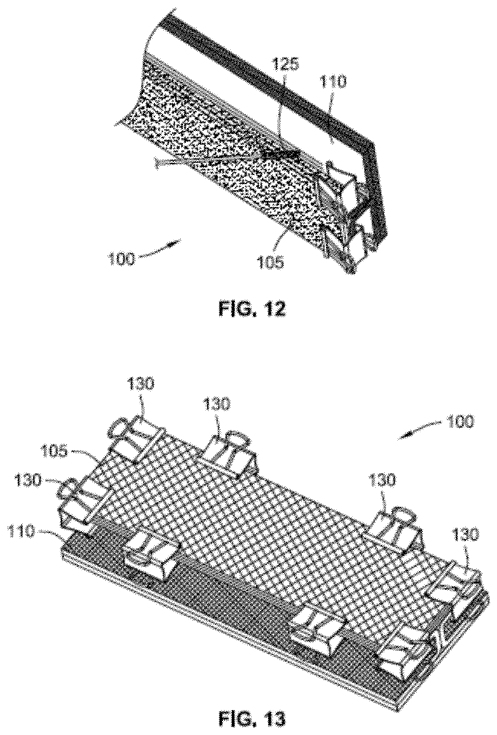

Referring now to FIG. 11, the delaminated ply 105 is glued, re-bonded, or reattached back together with the plies 110 that remain as part of the fiber preform in the predetermined position and is manually held 111 in place to assist in bonding between the delaminated ply 105 and the plies 110 remaining in the fiber preform 100. When desirable or necessary, rework slurry touch-up 125 may be performed on the reworked ply 105 as shown in FIG. 12. Clips, fasteners, or the like 130 may be added as shown in FIGS. 12 and 13 to hold plies 105, 110 together during final slurry touch-up 125 and/or to ensure that the plies 105, 110 are joined properly and will not separate during drying. This drying step is performed until the rework slurry has dried. The drying is accomplished at ambient temperature (about 20° C. to about 25° C.) for a predetermined amount of time, such as in this example, for 12 hours, followed by exposure to an elevated temperature for about two hours comprising about 1 hour at about 75° C. and about 1 hour at about 150° C. After the rework slurry is dried, the part is infiltrated 50 with a ceramic slurry to form a green body. This green body is then infiltrated 70 with a silicon alloy melt for final densification.

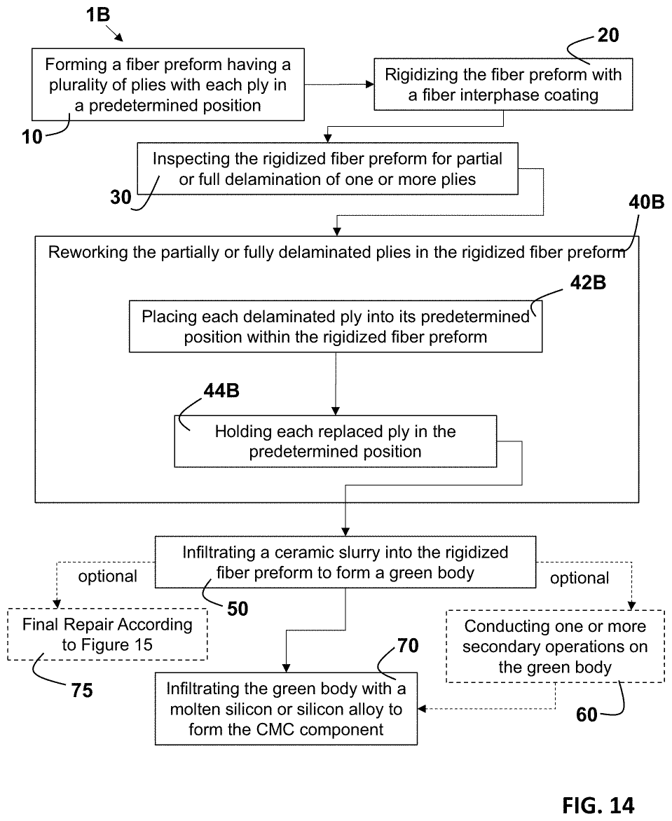

Referring now to FIG. 14, another method 1B of producing a ceramic matrix composite (CMC) component is provided according to another aspect of the present disclosure. This method 1B is similar to; alternatively, the same as method 1A, except for the step of reworking 40B the partially or fully delaminated plies in the rigidized preform. This method 1B comprises the steps of: forming 10 a fiber preform that comprises a plurality of ceramic fiber plies with each ceramic fiber ply occupying a predetermined position in the fiber preform; rigidizing 20 the fiber preform with a fiber interphase coating; inspecting 30 the rigidized fiber preform to determine which of the plurality of plies has partially or fully delaminated; reworking 40B the partially or fully delaminated plies in the rigidized fiber preform; infiltrating 50 a ceramic slurry into the rigidized fiber preform to form a green body; optionally, conducting 60 one or more secondary operations on the green body; and infiltrating 70 the green body with a molten silicon or silicon alloy to form the CMC component.

In method 1B, the step of reworking 40B the partially or fully delaminated plies in the rigidized fiber preform is further subdivided into multiple steps 42B, 44B that are involved in such a repair process. This repair process or steps involved in reworking 40B the partially or fully delaminated plies in the rigidized fiber preform comprises placing 42B each partially or fully delaminated ply into its predetermined position within the fiber preform; and holding 44B the reworked ply in the predetermined position, such that the replaced plies and/or the fiber preform do not move during the infiltration 50 of a ceramic slurry into the rigidized fiber preform to form the green body. Clips, fasteners, or any other mechanical means known in the art may be used to hold the replaced plies together with the fiber preform and to prevent movement during slurry infiltration 50 in order to ensure that the plies are joined properly with the fiber preform and will not separate during drying.

The composition of the ceramic slurry used to infiltrate 50 the fiber preform in this method 1B may be the same composition as that was described for the rework slurry in method 1A. As the ceramic slurry infiltrates 50 the fiber preform, the solid particulate fillers flow into the pores and interstices that exist between the ceramic fibers and between the plies. The infiltration 50 of the ceramic slurry may be accomplished in a single step or may comprise multiple infiltration steps in order to ensure that the fiber preform is fully impregnated with the solid particulate fillers. Each additional infiltration step may be performed using a ceramic slurry composition that is either the same as or different form the composition used in the first infiltration or impregnation step.

Still referring to FIG. 14, following slurry infiltration 50, the resulting green body may be subjected to 60 one or more secondary operations when necessary or desirable. After completion of any optional secondary processing operations 60, a molten metal or metal alloy is infiltrated 70 into the green body. These final two steps 60, 70 may be performed similar to or substantially the same as the steps by the same reference number described in relation to FIG. 1. After slurry infiltration 50, if a defect, such as partial or full delamination of a ply, is present in the green body, the green body may be subjected to a final repair process 75.

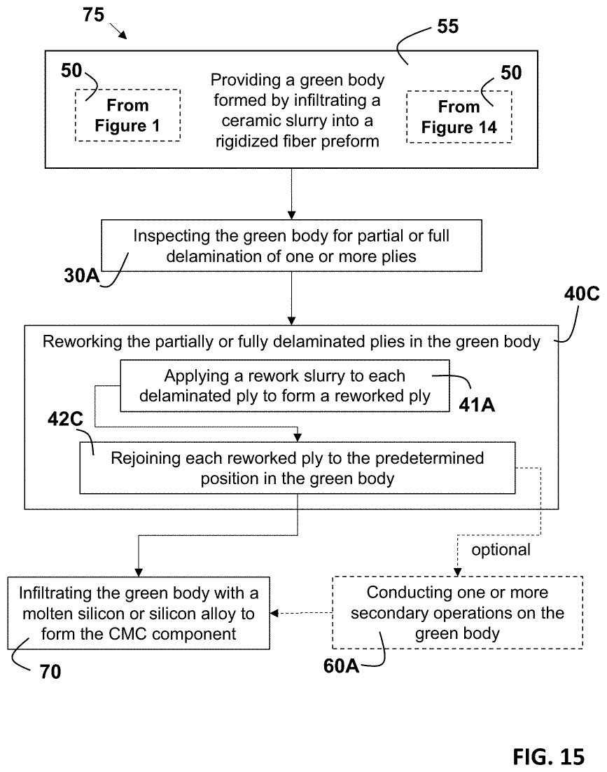

Referring now to FIG. 15, another method 1C of producing a ceramic matrix composite (CMC) component is provided. This method 1C applies multiple steps previously discussed with respect to methods 1A or 1 B to a green body instead of to a rigidized fiber preform. Method 1C generally comprises the steps of providing 55 a green body formed by infiltrating a ceramic slurry into a rigidized fiber preform; inspecting 30A the green body to determine if any plies has become partially or fully delaminated; reworking 40C the partially or fully delaminated plies in the green body; optionally, conducting 60A one or more secondary operations on the reworked green body; and infiltrating 70 the reworked green body with a molten silicon or silicon alloy to form the CMC component.

The green body provided in step 55 of method 1C may arise from infiltrating 50 a ceramic slurry into a rigidized preform according to method 1A or method 1B. In addition, this green body may also arise from any other method involving the infiltration of a ceramic slurry into a rigidized fiber preform.

In method 1C, the step of reworking 40C the partially or fully delaminated plies in the green body is further subdivided into multiple steps 41A, 42C that are involved in such a repair process. This repair process or steps involved in reworking 40C the partially or fully delaminated plies in the green body comprises steps of applying 41A a rework slurry to each delaminated ply to form a reworked ply; and rejoining 42C each reworked ply to the predetermined position in the green body.

The composition of the rework slurry used to rework 40C the green body in this method 1C may be the same composition as that was described for the rework slurry in method 1A. When desirable, the rework slurry used in method 1C may be similar to or substantially the same in composition as the ceramic slurry used to infiltrate the rigidized fiber preform to form the green body.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein. It should be further appreciated that throughout the description, corresponding reference numerals having the same number and a different letter, such as for example, 42A, 42B, and 42C indicate like or corresponding steps, elements, or features. These corresponding steps, elements, or features may be identical or comprise minor alterations, such as applying the step to a rigidized fiber preform prior to ceramic slurry infiltration or to a green body formed upon infiltrating of a ceramic slurry into a rigidized fiber preform.

The subject-matter of the disclosure may also relate, among others, to the following aspects:

A first aspect relates to a method of producing a ceramic matrix composite (CMC) component, the method comprising steps of: forming a fiber preform comprising a plurality of ceramic fiber plies; wherein each of the ceramic fiber plies occupies a predetermined position in the fiber preform; rigidizing the fiber preform with a fiber interphase coating; inspecting the rigidized fiber preform to determine which of the plurality of plies has partially or fully delaminated; reworking the partially or fully delaminated plies in the rigidized fiber preform; wherein reworking the partially or fully delaminated plies comprises the steps of: applying a rework slurry to each delaminated ply to form a reworked ply; rejoining each reworked ply to the predetermined position in the fiber preform; optionally, performing rework slurry touch-up on the reworked ply; and holding the reworked ply in the predetermined position until dry; infiltrating a ceramic slurry into the rigidized fiber preform to form a green body; optionally, conducting one or more secondary operations on the green body; and infiltrating the green body with a molten silicon or silicon alloy to form the CMC component.

A second aspect relates to the method of the first aspect, wherein the rework slurry consists of a plurality of solid particulate fillers, one or more reactive additives, a solvent, and optionally, one or more dispersants, binders, and/or gelation polymers.

A third aspect relates to the method of the second aspect, wherein the solid particulate fillers in the rework slurry comprise silicon carbide (SiC), silicon nitride (Si₃N₄), or a mixture thereof.

A fourth aspect relates to the method of the second or third aspect, wherein the one or more reactive additives in the rework slurry includes at least one of graphite, diamond, carbon black, molybdenum (Mo), and tungsten (W).

A fifth aspect relates to the method of any preceding aspect, wherein the rework slurry comprises a solid loading in the range of about 10 vol.% to about 70 vol.% relative to the overall volume of the rework slurry.

A sixth aspect relates to the method of any of the second through the fifth aspects, wherein the solvent in the rework slurry is either water or an organic solvent.

A seventh aspect relates to the method of any of the second through the sixth aspects, wherein the solvent in the rework slurry comprises a carbonaceous resin.

An eighth aspect relates to the method of any of the second through the seventh aspects, wherein the solvent in the rework slurry comprises a phenolic resin and furfuryl alcohol.

A ninth aspect relates to the method of any preceding aspect, wherein the rework slurry is thermally cured at a temperature range of about 100° C. to about 200° C. prior to melt infiltration of the silicon or silicon alloy.

A tenth aspect relates to the method of any preceding aspect, wherein applying a rework slurry to each delaminated ply to form a reworked ply comprises one or more of applying the rework slurry directly to the delaminated ply; applying the rework slurry directly to the ply in the fiber preform to which the delaminated ply should be attached; or applying the rework slurry between the delaminated ply and the ply in the fiber preform to which the delaminated ply should be attached

An eleventh aspect relates to the method of any preceding aspect, wherein the rework slurry is applied by spraying, dipping, pouring, flowing, or brushing.

A twelfth aspect relates to the method of any preceding aspect, wherein a composition of the rework slurry is the same as a composition of the ceramic slurry.

A thirteenth aspect relates to the method of any preceding aspect, wherein rigidizing the fiber preform with a fiber interphase coating uses a chemical vapor infiltration (CVI) process.

A fourteenth aspect relates to the method of any preceding aspect, wherein the fiber preform comprises fibers that include one or more of silicon carbide (SiC), silicon nitride (Si₃N₄), or a mixture thereof, and wherein the fiber interphase coating comprises silicon carbide (SiC), silicon nitride (Si₃N₄), or a mixture thereof.

A fifteenth aspect relates to a method of reworking a rigidized fiber preform during the production of a CMC component when at least one of a plurality of plies in the rigidized fiber preform exhibits partial or full delamination from a predetermined position in the rigidized fiber preform, the method comprising the steps of: applying a rework slurry to each delaminated ply to form a reworked ply; rejoining each reworked ply to the predetermined position in the fiber preform; optionally, performing rework slurry touch-up on the reworked ply; and holding the reworked ply in the predetermined position until dry.

A sixteenth aspect relates to the method of the fifteenth aspect, wherein the fiber preform comprises fibers that include one or more of silicon carbide (SiC), silicon nitride (Si₃N₄), or a mixture thereof, and wherein the fiber preform is rigidized via a chemical vapor infiltration (CVI) process with a fiber interphase coating that comprises silicon carbide (SiC), silicon nitride (Si₃N₄), or a mixture thereof.

A seventeenth aspect relates to the method of the fifteenth or sixteenth aspect, wherein the rework slurry consists of a plurality of solid particulate fillers, one or more reactive additives, a solvent, and optionally, one or more dispersants, binders, and/or gelation polymers, wherein the solid particulate fillers comprise silicon carbide (SiC), silicon nitride (Si₃N₄), or a mixture thereof present in a solid loading in the range of about 10 vol.% to about 70 vol.% relative to the overall volume of the ceramic slurry, and wherein the one or more reactive additives includes at least one of graphite, diamond, carbon black, molybdenum (Mo), and tungsten (W).

An eighteenth aspect relates to the method of the seventeenth aspect, wherein the solvent in the rework slurry comprises a carbonaceous resin, and wherein the rework slurry is thermally cured at a temperature range of about 100° C. to about 200° C. prior to melt infiltration of a silicon or silicon alloy.

A nineteenth aspect relates to the method of the seventeenth or eighteenth aspect, wherein the solvent in the rework slurry comprises a phenolic resin and furfuryl alcohol.

A twentieth aspect relates to the method of any of the fifteenth through the nineteenth aspects, wherein applying a rework slurry to each delaminated ply to form a reworked ply comprises one or more of applying the rework slurry directly to the delaminated ply; applying the rework slurry directly to the ply in the fiber preform to which the delaminated ply should be attached; or applying the rework slurry between the delaminated ply and the ply in the fiber preform to which the delaminated ply should be attached, and wherein applying the rework slurry is done by spraying, dipping, pouring, flowing, or brushing.

A twenty-first aspect relates to a method of producing a ceramic matrix composite (CMC) component, the method comprising steps of: forming a fiber preform comprising a plurality of ceramic fiber plies; wherein each of the ceramic fiber plies occupies a predetermined position in the fiber preform; rigidizing the fiber preform with a fiber interphase coating; inspecting the rigidized fiber preform to determine which of the plurality of plies has partially or fully delaminated; reworking the partially or fully delaminated plies in the rigidized fiber preform; wherein reworking the partially or fully delaminated plies comprises the steps of: placing each delaminated ply into the predetermined position within the fiber preform; and holding the replaced ply in the predetermined position; infiltrating a ceramic slurry into the rigidized fiber preform to form a green body; optionally, conducting one or more secondary operations on the green body; and infiltrating the green body with a molten silicon or silicon alloy to form the CMC component.

A twenty-second aspect relates to the twenty-first aspect, wherein the ceramic slurry consists of a plurality of solid particulate fillers, one or more reactive additives, a solvent, and optionally, one or more dispersants, binders, and/or gelation polymers; wherein the solid particulate fillers comprise silicon carbide (SiC), silicon nitride (Si₃N₄), or a mixture thereof present in a solid loading in the range of about 10 vol.% to about 70 vol.% relative to the overall volume of the ceramic slurry; wherein the one or more reactive additives includes at least one of graphite, diamond, carbon black, molybdenum (Mo), and tungsten (W); and wherein the solvent in the ceramic slurry comprises a carbonaceous resin.

A twenty-third aspect relates to the twenty-first or twenty-second aspects, wherein the fiber preform comprises fibers that include one or more of silicon carbide (SiC), silicon nitride (Si₃N₄), or a mixture thereof, and wherein the fiber preform is rigidized via a chemical vapor infiltration (CVI) process with a fiber interphase coating that comprises silicon carbide (SiC), silicon nitride (Si₃N₄), or a mixture thereof.

A twenty-fourth aspect relates to a method of producing a ceramic matrix composite (CMC) component, the method comprising steps of: providing a green body formed by infiltrating a ceramic slurry into a rigidized fiber preform; inspecting the green body to determine if any plies has become partially or fully delaminated; reworking the partially or fully delaminated plies in the green body; wherein reworking the partially or fully delaminated plies comprises the steps of: applying a rework slurry to each delaminated ply to form a reworked ply; and rejoining each reworked ply to the predetermined position in the green body; optionally, conducting one or more secondary operations on the reworked green body; and infiltrating the reworked green body with a molten silicon or silicon alloy to form the CMC component.

A twenty-fifth aspect relates to the method of the twenty-fourth aspect, wherein the composition of the rework slurry and the ceramic slurry are independently selected to consist of a plurality of solid particulate fillers, one or more reactive additives, a solvent, and optionally, one or more dispersants, binders, and/or gelation polymers; wherein the solid particulate fillers comprise silicon carbide (SiC), silicon nitride (Si₃N₄), or a mixture thereof present in a solid loading in the range of about 10 vol. % to about 70 vol. % relative to the overall volume of the rework slurry; wherein the one or more reactive additives includes at least one of graphite, diamond, carbon black, molybdenum (Mo), and tungsten (W); and wherein the solvent in the ceramic slurry comprises a carbonaceous resin.

A twenty-sixth aspect relates to the method of the twenty-fourth or twenty-fifth aspects, wherein a composition of the rework slurry is the same as a composition of the ceramic slurry.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of producing a ceramic matrix composite (CMC) component, the method comprising steps of:
forming a fiber preform comprising a plurality of ceramic fiber plies;
wherein each of the ceramic fiber plies occupies a predetermined position in the fiber preform;
rigidizing the fiber preform with a fiber interphase coating;
inspecting the rigidized fiber preform to determine which of the plurality of plies has partially or fully delaminated;
reworking the partially or fully delaminated plies in the rigidized fiber preform; wherein reworking the partially or fully delaminated plies comprises the steps of:
applying a rework slurry to each delaminated ply to form a reworked ply;
rejoining each reworked ply to the predetermined position in the fiber preform; and
holding the reworked ply in the predetermined position until dry;
infiltrating a ceramic slurry into the rigidized fiber preform to form a green body; and
infiltrating the green body with a molten silicon or silicon alloy to form the CMC component.

2. The method according to claim 1, wherein the rework slurry consists of a plurality of solid particulate fillers, one or more reactive additives, a solvent, and optionally, one or more dispersants, binders, and/or gelation polymers.

3. The method according to claim 2, wherein the solid particulate fillers in the rework slurry comprise silicon carbide (SiC), silicon nitride (Si₃N₄), or a mixture thereof.

4. The method according to claim 2, wherein the one or more reactive additives in the rework slurry includes at least one of graphite, diamond, carbon black, molybdenum (Mo), and tungsten (W).

5. The method according to claim 2, wherein the rework slurry comprises a solid loading in the range of about 10 vol.% to about 70 vol.% relative to the overall volume of the rework slurry.

6. The method according to claim 2, wherein the solvent in the rework slurry is either water or an organic solvent.

7. The method according to claim 6, wherein the solvent in the rework slurry comprises a carbonaceous resin and/or
wherein the solvent in the rework slurry comprises a phenolic resin and furfuryl alcohol.

8. The method according to claim 1, further comprising: performing rework slurry touch-up on the reworked ply, and/or conducting one or more secondary operations on the green body.

9. The method according to claim 1, wherein the rework slurry is thermally cured at a temperature range of about 100° C. to about 200° C. prior to melt infiltration of the silicon or silicon alloy.

10. The method according to claim 1, wherein applying a rework slurry to each delaminated ply to form a reworked ply comprises one or more of applying the rework slurry directly to the delaminated ply; applying the rework slurry directly to the ply in the fiber preform to which the delaminated ply should be attached; or applying the rework slurry between the delaminated ply and the ply in the fiber preform to which the delaminated ply should be attached.

11. The method according to claim 10, wherein the rework slurry is applied by spraying, dipping, pouring, flowing, or brushing.

12. The method according to claim 1, wherein a composition of the rework slurry is the same as a composition of the ceramic slurry.

13. The method according to claim 1, wherein rigidizing the fiber preform with a fiber interphase coating uses a chemical vapor infiltration (CVI) process.

14. The method according to claim 1, wherein the fiber preform comprises fibers that include one or more of silicon carbide (SiC), silicon nitride (Si₃N₄), or a mixture thereof, and
wherein the fiber interphase coating comprises silicon carbide (SiC), silicon nitride (Si₃N₄), or a mixture thereof.

15. A method of reworking a rigidized fiber preform during the production of a CMC component when at least one of a plurality of plies in the rigidized fiber preform exhibits partial or full delamination from a predetermined position in the rigidized fiber preform; the method comprising the steps of:
applying a rework slurry to each delaminated ply to form a reworked ply;
rejoining each reworked ply to the predetermined position in the fiber preform; and
holding the reworked ply in the predetermined position until dry.

16. The method according to claim 15, further comprising: performing rework slurry touch-up on the reworked ply.

17. The method according to claim 15, wherein the rework slurry consists of a plurality of solid particulate fillers, one or more reactive additives, a solvent, and optionally, one or more dispersants, binders, and/or gelation polymers;
wherein the solid particulate fillers comprise silicon carbide (SiC), silicon nitride (Si₃N₄), or a mixture thereof present in a solid loading in the range of about 10 vol. % to about 70 vol. % relative to the overall volume of the ceramic slurry; and
wherein the one or more reactive additives includes at least one of graphite, diamond, carbon black, molybdenum (Mo), and tungsten (W).

18. The method according to claim 15, wherein the fiber preform comprises fibers that include one or more of silicon carbide (SiC), silicon nitride (Si₃N₄), or a mixture thereof; and
wherein the fiber preform is rigidized via a chemical vapor infiltration (CVI) process with a fiber interphase coating that comprises silicon carbide (SiC), silicon nitride (Si₃N₄), or a mixture thereof.

19. The method according to claim 16, wherein the solvent in the rework slurry comprises a carbonaceous resin, a phenolic resin and/or furfuryl alcohol, and
wherein the rework slurry is thermally cured at a temperature range of about 100° C. to about 200° C. prior to melt infiltration of a silicon or silicon alloy.

20. The method according to claim 15, wherein applying a rework slurry to each delaminated ply to form a reworked ply comprises one or more of applying the rework slurry directly to the delaminated ply; applying the rework slurry directly to the ply in the fiber preform to which the delaminated ply should be attached; or applying the rework slurry between the delaminated ply and the ply in the fiber preform to which the delaminated ply should be attached; and
wherein applying the rework slurry is done by spraying, dipping, pouring, flowing, or brushing.
